(19) United States
(12) Patent Application Publication
(10) Pub. No.: US 2018/0178635 A1
(43) Pub. Date: Jun. 28, 2018

(54) VEHICULAR FRONT WINDOW SUNSHADE APPARATUS

(71) Applicant: Yoel BERMAN, Beer Sheva (IL)

(72) Inventor: Yoel BERMAN, Beer Sheva (IL)

(21) Appl. No.: 15/390,753

(22) Filed: Dec. 27, 2016

(51) Int. Cl. B60J 1/20

(52) U.S. Cl. CPC B60J 1/2091

(57) ABSTRACT

The present invention is directed to a vehicular sunshade apparatus (10) comprising: a sunshade (12); and a sunshade (12); and a hooking device (34, 36, 40, 42, 44), for connecting the sunshade (12) to a sun visor elbow (30) of a vehicle, wherein the sun visor elbow being a bent shaft connecting the sun visor (22) to a wall of the vehicle and disposed at a side of the vehicle. According to one embodiment of the invention, the hooking device is a ferromagnetic patch (42) attached to the sunshade (12) and the element (40) of a sun visor is a magnet attached to the elbow (30). According to another embodiment of the invention, the hooking device is a Velcro patch (42) and the element (40) of a sun visor is a corresponding Velcro element (40) attached to the elbow (30).

### TECHNICAL FIELD

The present invention relates to the field of vehicular sunshades.

### BACKGROUND ART

FIGS. 1a and 1b schematically illustrate a common vehicular sunshade apparatus, according to the prior art.

FIG. 2 schematically illustrates the apparatus of FIG. 1, in a folded state thereof.

The vehicular sunshade apparatus, which is marked herein by reference numeral 10, comprises a foldable sunshade 12, preferably coated with sunbeam non-absorbing material, such as nickel-like material.

The vehicular sunshade makes use of suction cups 14 (such suction cups are illustrated in FIG. 3) for attaching the sunshade to a vehicle window, preferably the front window. In addition, the apparatus comprises loops 16 for holding the apparatus folded when not in use, thereby making the apparatus compact in storage.

FIG. 1a illustrates the apparatus with its suction cups. The suction cups can be removed, and FIG. 1b illustrates the apparatus without the suction cups. The suction cups are inserted into holes 18 seen in FIG. 1b.

Due to its compactness, this form of vehicular sunshade is very common. On the other hand, a substantial disadvantage of the apparatus is that the effectiveness of the suction cup decreases drastically within a few months after being in use due to its exposure to sunbeams. Actually its attaching ability is defected, and the suction cup detaches from the vehicle window within a few minutes after being mounted.

An additional drawback is the complexity of mounting the apparatus, as the user needs to press the suction cups against the vehicle window and make sure it does not attach.

It is an object of the present invention to provide a solution to the above-mentioned and other problems of the prior art.

Other objects and advantages of the invention will become apparent as the description proceeds.

### SUMMARY OF THE INVENTION

The present invention is directed to a vehicular sunshade apparatus (10) comprising:
a sunshade (12); and
a hooking device (34, 36, 40, 42, 44), for connecting the sunshade (12) to a sun visor elbow (30) of a vehicle,
wherein the sun visor elbow being a bent shaft connecting the sun visor (22) to a wall of the vehicle and disposed at a side of the vehicle.

According to one embodiment of the invention, the hooking device is adapted to support the sunshade (12) from falling down.

According to one embodiment of the invention, the hooking device comprises:
a strap (34);
a first hook (36) connected to a first end of the strap (34), for connecting the first hook to the elbow (30); and
a second hook (36) connected to a second end of the strap (34), for connecting the second hook to the sunshade (12).

According to one embodiment of the invention, the hooking device comprises:
a strap (34);
a hook (36) connected to a first end of the strap (34), for connecting the hook to the sunshade (12); and
a loop (38) at a second end of the strap (34), for connecting thereof to the elbow (30).

The strap (34) may be elastic, or non-elastic. In the later case, the strap (34) preferably comprises means for adapting the length thereof.

According to one embodiment of the invention, the hooking device is a ferromagnetic patch (42) attached to the sunshade (12) and the element (40) of a sun visor is a magnet attached to the elbow (30). The magnet is preferably in a form of a ring, for allowing connecting it to the elbow.

According to one embodiment of the invention, the hooking device is a clothespin (44) having a hook (36) connected to a leg thereof. In use the clothespin is attached to a sunshade.

According to another embodiment of the invention, the hooking device is a Velcro patch (42) and the element (40) of a sun visor is a corresponding Velcro element (40) attached to the elbow (30). The corresponding Velcro element (40) is preferably in a form of a ring, for allowing connecting it to the elbow.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIGS. 1a and 1b schematically illustrate a common vehicular sunshade apparatus, according to the prior art.

FIG. 2 schematically illustrates the apparatus of FIG. 1, in a folded state thereof.

FIG. 3 schematically illustrates two suction cups of the sunshade apparatus of FIG. 1.

FIG. 4 schematically illustrates a sun visor, according to the prior art.

FIG. 5 schematically illustrates a vehicular sunshade apparatus 10 installed in a vehicle, according to one embodiment of the invention.

FIG. 6 pictorially illustrates a hooking device, according to one embodiment of the invention.

FIG. 7 pictorially illustrates a hooking device, according to another embodiment of the invention.

FIG. 8 is a sectional view on a vehicle cabin in which is installed a sunshade apparatus 10, according to one embodiment of the invention.

FIG. 9 pictorially illustrates a sunshade apparatus, according to yet another embodiment of the invention.

FIGS. 10a and 10b pictorially illustrate a sunshade apparatus, according to yet another embodiment of the invention.

FIG. 11 pictorially illustrate a hooking device sunshade apparatus, according to yet another embodiment of the invention.

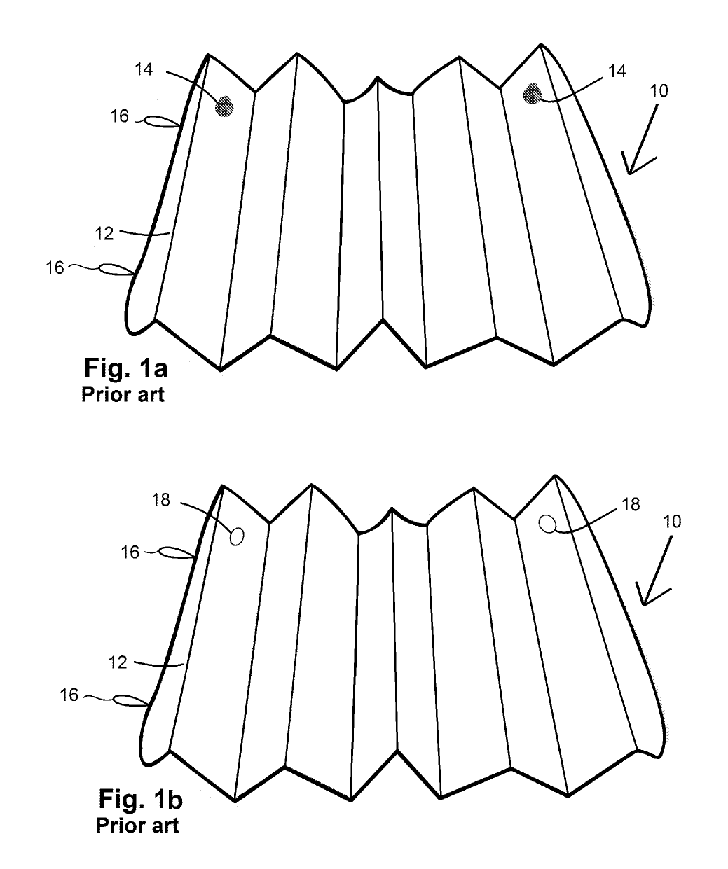

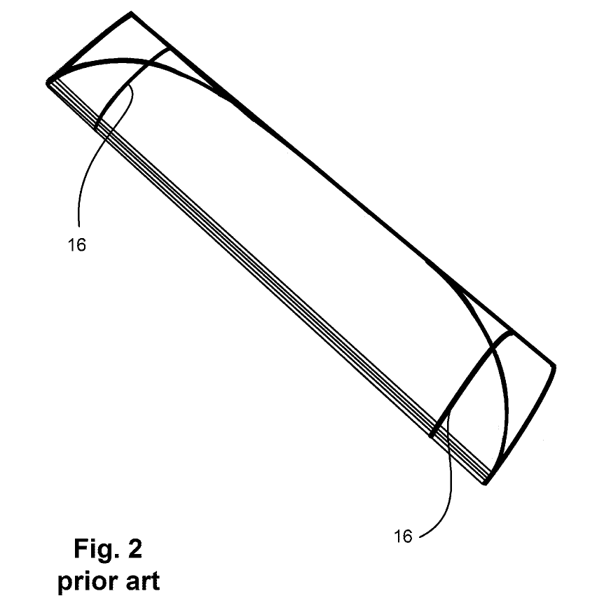

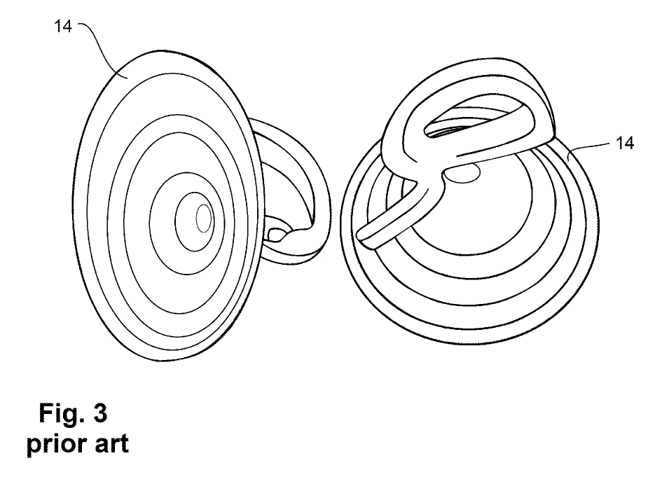

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

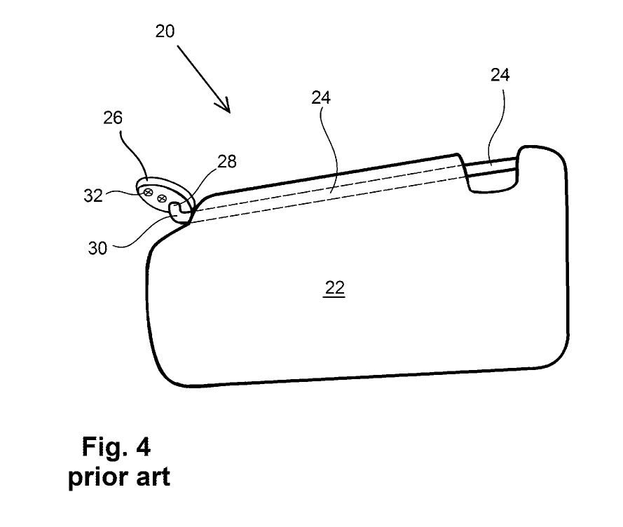

FIG. 4 schematically illustrates a sun visor, according to the prior art.

The sun visor, which is marked herein by reference numeral 20, comprises a shading board 22, and two hinges, a vertical hinge 28 and a horizontal hinge 24. The vertical hinge 28 is connected to tab 26 which connects to the vehicle body by bolts 32.

The horizontal hinge 24 and the vertical hinge 28 are actually the same element, a bent rod. The elbow, i.e., the bent region of the rod, is marked by reference numeral 30.

It should be noted that elbow 30 is exposed, and as such according to embodiments of the present invention it is used as an element, to which the sunshade is hooked.

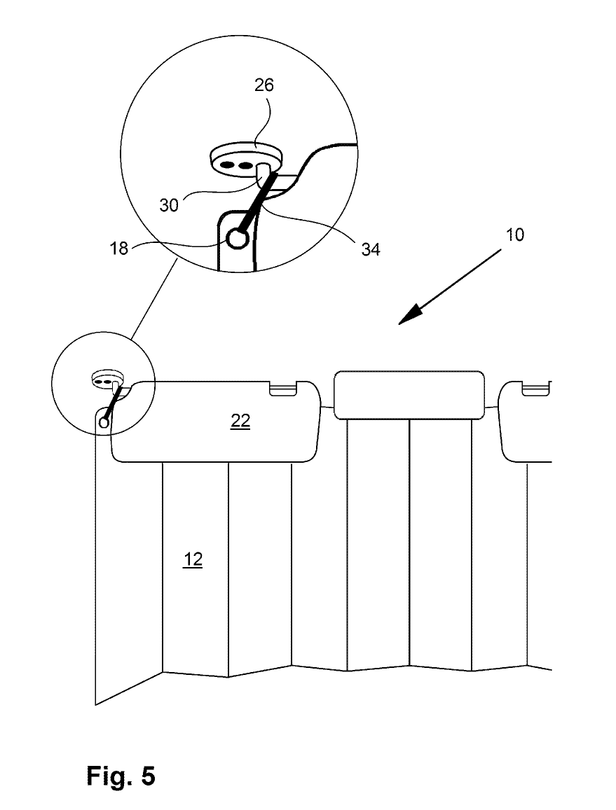

FIG. 5 schematically illustrates a vehicular sun sunshade apparatus 10 installed in a vehicle, according to one embodiment of the invention.

The apparatus makes use of elbow 30 to hook thereto the sunshade 12. As the elbow 30 is exposed in the majority of the vehicles in which a sun visor of this type is installed, the present invention makes use of the elbow for hooking thereto the sunshade 12. The element of the apparatus which hooks to the elbow is referred herein as to hooking device.

According to this embodiment of the invention, the hooking device is a strap 34, which hooks to both, elbow 30 of the sun visor, and hole 18 of the sunshade 12. Thus, the hooking device replaces the suction cup of the prior art.

Strap 34 may be made of elastic material as well as non-elastic material. When using a non-elastic strap, preferably the strap has to be coupled with means to adjust its length, like a pants belt, a bag belt, and so on.

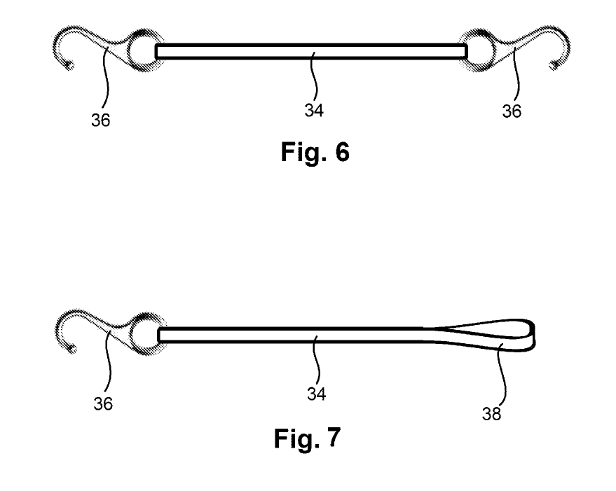

FIG. 6 pictorially illustrates a hooking device, according to one embodiment of the invention.

The hooking device illustrated in this figure comprises a strap 34 and two hooks 36, each connected to strap 34 at an end thereof.

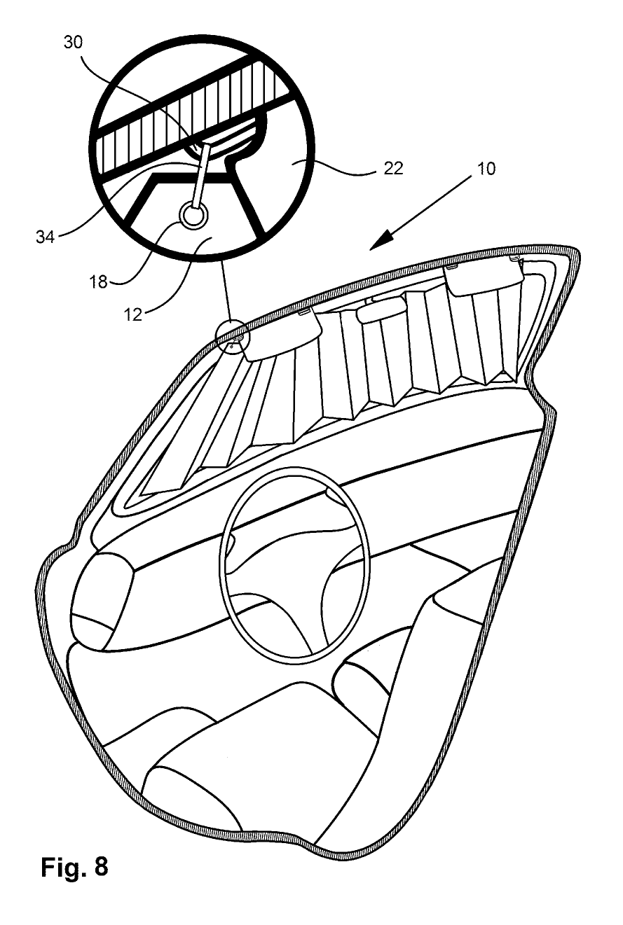

FIG. 7 pictorially illustrates a hooking device, according to another embodiment of the invention.

The hooking device illustrated in this figure comprises a strap 34, one hook 36 at one end of the strap, and a loop 38 at the other end of the strap. The loop can be used as a tie, thereby replacing the other hook of the embodiment of FIG. 6.

FIG. 8 is a sectional view on a vehicle cabin in which is installed a sunshade apparatus 10, according to one embodiment of the invention.

The zoomed view details the way the sunshade apparatus 10 is connected to the elbow 30 of the sun visor. The hooking device is a strap 34 which is connected at one end thereof to the sun visor elbow 30, and at the other end thereof to hole 18 of the sunshade 12.

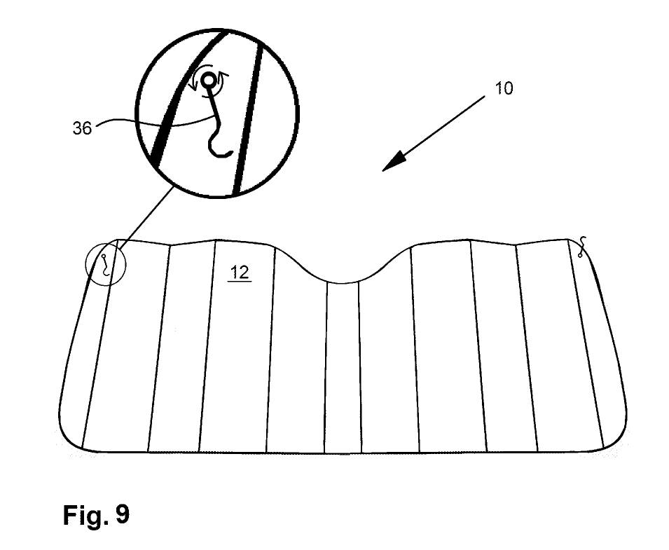

FIG. 9 pictorially illustrates a sunshade apparatus, according to yet another embodiment of the invention.

According to this embodiment of the invention, the hooking device is a hook 36, connected directly to the sunshade 12. The hook orientation with regard to the sunshade 12 (i.e., perpendicular to each other, parallel to each other, and so on) may differ from the orientation illustrated in this figure.

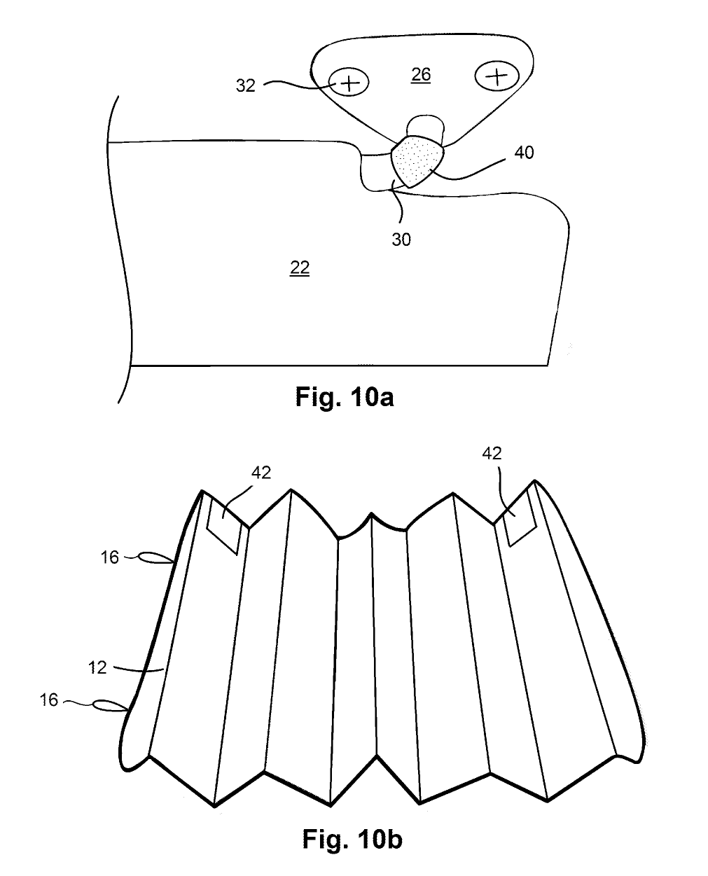

FIGS. 10a and 10b pictorially illustrate a sunshade apparatus, according to yet another embodiment of the invention.

Each of numeral references 40 and 42 refer to an element which can be attached and/or connected to the other. Element 40 is attached to elbow 30 of the illustrated sun visor.

According to one embodiment of the invention, element 40 is a magnet and element 42 is a ferromagnetic patch. As such, when the ferromagnetic patch 42 is approached to magnet 40, they are attracted to each other, thereby generating a connection mechanism which easily can be setup and dismantled.

According to another embodiment of the invention, element 40 is a Velcro ring connected to elbow 30, and element 42 is a corresponding Velcro patch. This solution also provides a connection mechanism which easily can be setup and dismantled.

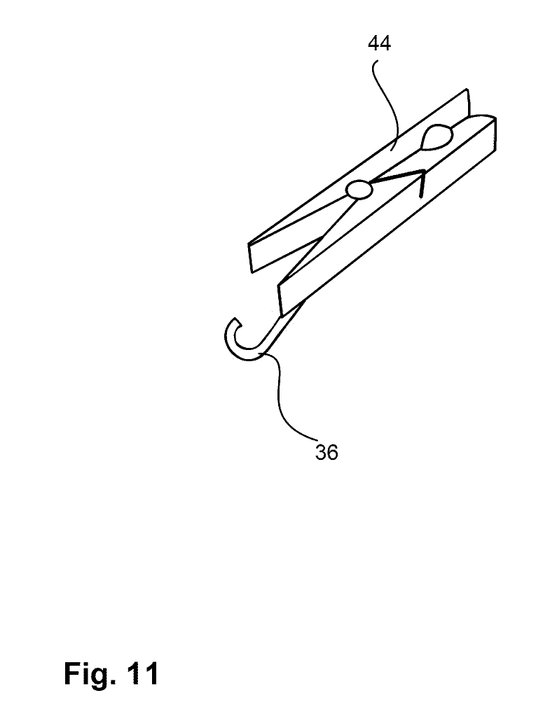

FIG. 11 pictorially illustrate a hooking device sunshade apparatus, according to yet another embodiment of the invention.

The figure shows a hook 36 connected to a clothespin 44. In use, the hook 36 is connected to an elbow of a sun visor (not illustrated in this figure), while the clothespin is attached to a sunshade.

In the figures and/or description herein, the following reference numerals (Reference Signs List) have been mentioned:
numeral 10 denotes a vehicular sunshade apparatus;
numeral 12 denotes a sunshade of the apparatus;
numeral 14 denotes a suction cup;
numeral 16 denotes a loop;
numeral 18 denotes a hole in sunshade 12;
numeral 20 denotes a sun visor;
numeral 22 denotes a shading board of sun visor 20;
numeral 24 denotes a horizontal hinge of sun visor 20;
numeral 26 denotes a tab connected to a vehicle;
numeral 28 denotes a vertical hinge of sun visor 20;
numeral 30 denotes an “elbow” (a bent shaft used as horizontal hinge (24) of said sun visor and a vertical hinge (28) of said sun visor, and disposed at a side of a vehicle thereof);
numeral 32 denotes a bolt;
numeral 34 denotes a strap;
numeral 36 denotes a hook;
numeral 38 denotes a loop of strap 34;
numeral 40 denotes a connecting element such as magnet or Velcro, preferably in a ring form; and
numeral 42 denotes a corresponding connecting element to element 40, such as a ferromagnetic patch or Velcro patch.

CN203818998 is considered as the closest prior art. It discloses a sunshade cloth that hangs on a sun visor clip. In order to maintain the sunshade cloth straight, the disclosure uses a stiff frame. In addition the disclosure uses a case into which the sunshade cloth is rolled. The clips in the disclosure reside at the center of the vehicle, in contrast to the present invention in which the hooking devices reside at the sides of the vehicle and therefore allow using prior art sunshade cloth without modifications.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A vehicular sunshade apparatus (10) comprising:
a sunshade (12); and
a hooking device comprising a Velcro ring (40) adapted to be disposed around a sun visor elbow (30) and a corresponding Velcro patch (42) disposed at an edge of said sunshade (12), for connecting said sunshade (12) to said sun visor elbow (30) of a vehicle,
wherein said sun visor elbow being a bent shaft connecting said sun visor (22) to a wall of said vehicle and disposed at a side of said vehicle.

2. An apparatus according to claim 1, wherein said hooking device is adapted to support said sunshade (12) from falling down.

3. An apparatus according to claim 1, wherein said hooking device comprises:
a strap (34);
a first hook (36) connected to a first end of said strap (34), for connecting said first hook to said elbow (30); and
a second hook (36) connected to a second end of said strap (34), for connecting said second hook to said sunshade (12).

4. An apparatus according to claim 1, wherein said hooking device comprises:
a strap (34);
a hook (36) connected to a first end of said strap (34), for connecting said hook to said sunshade (12); and
a loop (38) at a second end of said strap (34), for connecting thereof to said elbow (30).

5. An apparatus according to claim 3, wherein said strap (34) is elastic.

6. An apparatus according to claim 3, wherein said strap (34) is non-elastic.

7. An apparatus according to claim 6, wherein said strap (34) further comprising means for adapting a length thereof.

8. (canceled)

9. (canceled)

10. (canceled)

11. (canceled)

12. An apparatus according to claim 1, wherein said hooking device is a clothespin having a hook connected to a leg thereof.

13. (canceled)

14. A vehicular sunshade apparatus (10) comprising:
a sunshade (12); and
a hooking device comprising a magnetic ring (40) adapted to be disposed around a sun visor elbow (30) and a corresponding ferromagnetic patch (42) disposed at an edge of said sunshade (12), for connecting said sunshade (12) to said sun visor elbow (30) of a vehicle,
wherein said sun visor elbow being a bent shaft connecting said sun visor (22) to a wall of said vehicle and disposed at a side of said vehicle.
